(19) United States
(12) Patent Application Publication
(10) Pub. No.: US 2025/0097643 A1
(43) Pub. Date: Mar. 20, 2025

(54) ACOUSTIC SIGNAL PROCESSING APPARATUS AND ACOUSTIC SIGNAL PROCESSING METHOD

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventor: Tatsuhiko GOTO, Kawasaki Kanagawa (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 18/583,988

(22) Filed: Feb. 22, 2024

(30) Foreign Application Priority Data
Sep. 15, 2023 (JP) 2023-150448

(51) Int. Cl. H04R 5/04; H04S 7/00

(52) U.S. Cl. CPC H04R 5/04; H04S 7/307; H04R 2420/01; H04S 2420/07

(57) ABSTRACT

According to an embodiment, an acoustic signal processing apparatus includes processing circuitry. The processing circuitry includes a modulation frequency control unit, frequency shift processing unit, and amplitude control unit. The modulation frequency control unit is configured to control a first modulation frequency based on velocity information indicating a velocity of a sound source. The frequency shift processing unit is configured to perform single-sideband (SSB) modulation on a first acoustic signal in accordance with the first modulation frequency to generate a first modulated acoustic signal. The amplitude control unit is configured to control an amplitude of the first modulated acoustic signal.

### CROSS-REFERENCE TO RELATED APPLICATION

This application is based upon and claims the benefit of priority from Japanese Patent Application No. 2023-150448, filed Sep. 15, 2023, the entire contents of which are incorporated herein by reference.

### FIELD

Embodiments described herein relate generally to an acoustic signal processing apparatus and an acoustic signal processing method.

### BACKGROUND

There is known a technique of implementing sound image localization in the left-right direction using two loudspeakers arranged in the horizontal direction. Sound image localization in the left-right direction can generally be implemented using the difference of arrival times of sound to two ears. On the other hand, sound image localization in the up-down direction can be recognized even without the difference of arrival times of sound to the two ears. Hence, to implement sound image localization in the up-down direction, another approach is needed.

There are technical difficulties in implementing sound image localization in the up-down direction using an omnidirectional loudspeaker group (two or more omnidirectional loudspeakers) arranged in the horizontal direction. Also usable is a method of creating a stereophonic sound by arranging, toward a diagonally upward side, a sound bar including loudspeakers arranged in line, but the hardware cost is high.

### BRIEF DESCRIPTION OF THE DRAWINGS

FIG. 1 is a block diagram showing an acoustic signal processing apparatus according to the embodiment.

FIG. 2 is a block diagram showing a modulation frequency control unit shown in FIG. 1.

FIG. 3 is a view showing a frequency shift achieved by the acoustic signal processing apparatus shown in FIG. 1.

FIG. 4 is a view for explaining a parameter setting unit shown in FIG. 1.

FIG. 5 is a block diagram showing an acoustic signal processing apparatus according to a moving sound source application (A).

FIG. 6 is a block diagram showing an acoustic signal processing apparatus according to a moving sound source application (B).

FIG. 7A is a view showing an acoustic signal according to an example of the moving sound source application (B).

FIG. 7B is a view showing a velocity change table according to the example of the moving sound source application (B).

FIG. 7C is a view showing a modulation frequency according to the example of the moving sound source application (B).

FIG. 7D is a view showing amplitude control according to the example of the moving sound source application (B).

FIG. 8A is a view showing an acoustic signal obtained by processing the acoustic signal shown in FIG. 7A by the acoustic signal processing apparatus shown in FIG. 6.

FIG. 8B is a view showing a part of FIG. 8A in an enlarged state.

FIG. 8C is a view showing a part of FIG. 8B in an enlarged state.

FIG. 9A is a view showing an acoustic signal obtained by processing the acoustic signal shown in FIG. 7A by the acoustic signal processing apparatus shown in FIG. 6.

FIG. 9B is a view showing a part of FIG. 9A in an enlarged state.

FIG. 9C is a view showing a part of FIG. 9B in an enlarged state.

FIG. 10 is a block diagram showing an acoustic signal processing apparatus according to a moving sound source application (C).

FIG. 11A is a view showing an acoustic signal according to an example of the moving sound source application (C).

FIG. 11B is a view showing a velocity change table according to the example of the moving sound source application (C).

FIG. 11C is a view showing a modulation frequency according to the example of the moving sound source application (C).

FIG. 12A is a view showing an acoustic signal obtained by processing the acoustic signal shown in FIG. 11A by the acoustic signal processing apparatus shown in FIG. 10.

FIG. 12B is a view showing an acoustic signal obtained by processing the acoustic signal shown in FIG. 7A by the acoustic signal processing apparatus shown in FIG. 6.

FIG. 13A is a view showing an acoustic signal obtained by processing the acoustic signal shown in FIG. 7A by the acoustic signal processing apparatus shown in FIG. 6.

FIG. 13B is a view showing an acoustic signal obtained by processing the acoustic signal shown in FIG. 7A by the acoustic signal processing apparatus shown in FIG. 6.

FIG. 14 is a block diagram showing the hardware configuration of the acoustic signal processing apparatus according to the embodiment.

### DETAILED DESCRIPTION

According to an embodiment, an acoustic signal processing apparatus includes processing circuitry. The processing circuitry includes a modulation frequency control unit, frequency shift processing unit, and amplitude control unit. The modulation frequency control unit is configured to control a first modulation frequency based on velocity information indicating a velocity of a sound source. The frequency shift processing unit is configured to perform single-sideband (SSB) modulation on a first acoustic signal in accordance with the first modulation frequency to generate a first modulated acoustic signal. The amplitude control unit is configured to control an amplitude of the first modulated acoustic signal.

Hereinafter, embodiments will be described with reference to the accompanying drawings.

The embodiment is related to a sound image localization method using a frequency shift. The sound image localization method using a frequency shift according to the embodiment can easily implement sound image localization in the up-down direction. For example, the sound image localization method using a frequency shift according to the embodiment can implement sound image localization in the up-down direction using two omnidirectional loudspeakers arranged in the horizontal direction.

If the pitch transitions from a low tone to a high tone, humans sense (have an illusion) as if the sound source is moving in the upward direction. To the contrary, if the pitch transitions from a high tone to a low tone, humans sense as if the sound source is moving in the downward direction. This is probably because they have experiences of viewing launch of rockets, takeoff/landing (spin-up or spin-down) of drones, and the like. In light of this, an acoustic signal processing apparatus capable of simulating a moving sound source will be described shown in the embodiment. Basically, the sound image localization method according to the embodiment simulates a moving sound source using a Doppler shift. Note that the sound image localization method according to the embodiment can be applied not only to sound image localization in the up-down direction but also to moving sound source simulation, and the application range is wide.

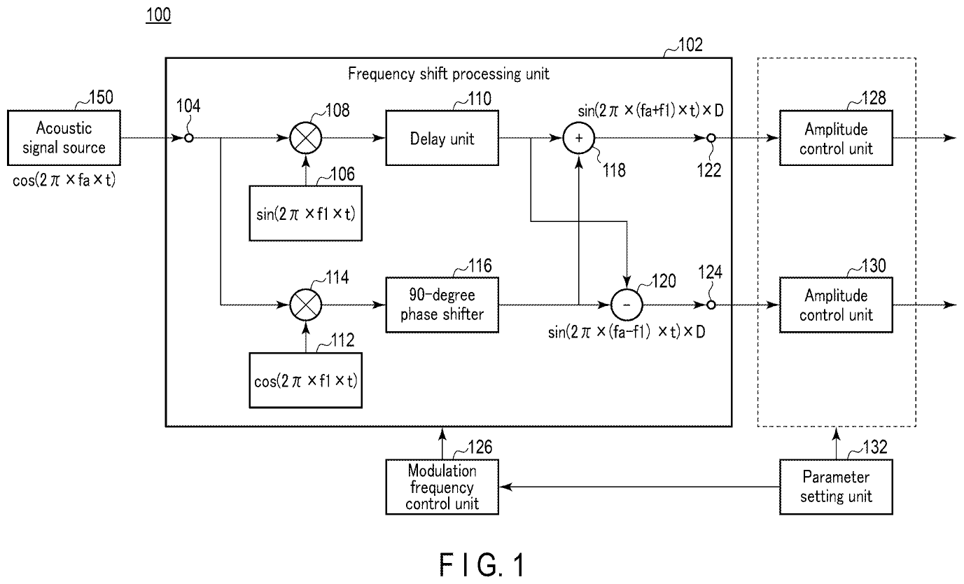

FIG. 1 schematically shows an example of the configuration of an acoustic signal processing apparatus 100 according to the embodiment. As shown in FIG. 1, the acoustic signal processing apparatus 100 includes a frequency shift processing unit 102, a modulation frequency control unit 126, amplitude control units 128 and 130, and a parameter setting unit 132. The frequency shift processing unit 102 applies a frequency shift corresponding to a modulation frequency f1 controlled by the modulation frequency control unit 126 to an acoustic signal. In this embodiment, the velocity of a sound source is set in advance, a Doppler shift amount is calculated from the velocity of the sound source, and the calculated Doppler shift amount is used as the modulation frequency f1. The Doppler shift amount indicates a frequency change caused by a Doppler shift.

According to the Doppler shift, if a sound source that generates a sound of a frequency fa moves away from an observer at a velocity v, the observer observes a sound of a frequency fb represented by

$$f b = \frac{c}{c + v} f a = ( 1 - \frac{v}{c + v} ) f a \qquad ( 1 )$$

where c is the speed of sound. The Doppler shift amount is (−v/(c+v))fa. If the sound source comes closer (if v is negative), the frequency becomes high. If the sound source moves away, the frequency becomes low.

The modulation frequency f1 is decided to implement the Doppler shift amount. Specifically, the modulation frequency f1 is calculated in accordance with

$$f 1 = - \frac{ν}{c + v} f a \qquad ( 2 )$$

where fa is the reference frequency representing the input acoustic signal. The reference frequency fa may be designated by a human operator who operates the acoustic signal processing apparatus 100.

The frequency shift processing unit 102 includes an input terminal 104, a sine wave signal generator 106, a multiplier 108, a delay unit 110, a cosine wave signal generator 112, a multiplier 114, a 90-degree phase shifter 116, an adder 118, a subtractor 120, and output terminals 122 and 124.

An acoustic signal source 150 that supplies an acoustic signal is connected to the input terminal 104. The first input port of the multiplier 108 is connected to the input terminal 104, and the second input port of the multiplier 108 is connected to the sine wave signal generator 106. The output port of the multiplier 108 is connected to the input port of the delay unit 110. The output port of the delay unit 110 is connected to the first input port of the adder 118 and the first input port of the subtractor 120. The first input port of the multiplier 114 is connected to the input terminal 104, and the second input port of the multiplier 114 is connected to the cosine wave signal generator 112. The output port of the multiplier 114 is connected to the input port of the 90-degree phase shifter 116. The output port of the 90-degree phase shifter 116 is connected to the second input port of the adder 118 and the second input port of the subtractor 120. The output port of the adder 118 is connected to the output terminal 122. The output port of the subtractor 120 is connected to the output terminal 122.

An acoustic signal from the acoustic signal source 150 is input to the input terminal 104. The acoustic signal can be represented by cos(2π×fa×t). The acoustic signal is branched into two signals, and these are input to the multiplier 108 and the multiplier 114.

The sine wave signal generator 106 generates a sine wave signal sin(2π×f1×t) of the modulation frequency f1. The multiplier 108 multiplies the acoustic signal input from the first input port by the sine wave signal input from the second input port. A signal output from the multiplier 108 is {sin(2π×(fa+f1)×t)+sin(2π×(f1−fa)×t)}/2. The delay unit 110 delays the output signal of the multiplier 108 by a predetermined time. The predetermined time matches a delay time included in the 90-degree phase shifter 116. The signal output from the delay unit 110 is {sin(2π×(fa+f1)×t)−sin(2π×(fa−f1)×t)}/2×D. D represents the delay caused by the delay unit 110.

The cosine wave signal generator 112 generates a cosine wave signal cos(2π×f1×t) of the modulation frequency f1. The multiplier 114 multiplies the acoustic signal input from the first input port by the cosine wave signal input from the second input port. A signal output from the multiplier 114 is {cos(2π×(fa+f1)×t)+cos(2π×(fa−f1)×t)}/2. The 90-degree phase shifter 116 applies a phase shift of −π/2 to the output signal of the multiplier 114. The 90-degree phase shifter 116 may be implemented using, for example, a Hilbert transformer. A signal output from the 90-degree phase shifter 116 is {sin(2π×(fa+f1)×t)+sin(2π×(fa−f1)×t)}/2×D. D represents the delay caused by the 90-degree phase shifter 116.

The adder 118 adds the output signal of the 90-degree phase shifter 116 and the output signal of the delay unit 110. A signal output from the adder 118 is sin(2π×(fa+f1)×t)×D. In this way, an acoustic signal whose frequency is shifted by f1 is obtained at the output terminal 122.

The subtractor 120 subtracts the output signal of the delay unit 110 from the output signal of the 90-degree phase shifter 116. A signal output from the subtractor 120 is sin(2π×(fa−f1)×t)×D. In this way, an acoustic signal whose frequency is shifted by −f1 is obtained at the output terminal 124.

The output terminal at which the acoustic signal whose frequency is shifted by f1 is obtained will sometimes be referred to as a positive-side output terminal, and the output terminal at which the acoustic signal whose frequency is shifted by −f1 is obtained will sometimes be referred to as a negative-side output terminal hereinafter.

The above-described signal processing performed by the frequency shift processing unit 102 is similar to single-sideband (SSB) modulation used in the wireless communication field. In this specification, the above-described signal processing performed by the frequency shift processing unit 102 will be referred to as SSB modulation. The frequency shift processing unit 102 performs SSB modulation on the acoustic signal and obtains the acoustic signal whose frequency is shifted.

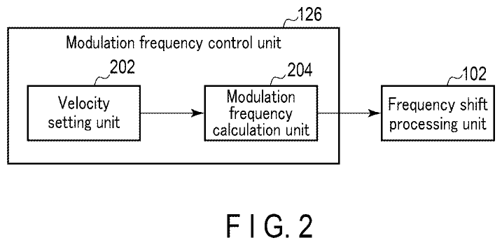

The modulation frequency control unit 126 will be described with reference to FIG. 2. The modulation frequency control unit 126 controls the modulation frequency f1 set in the sine wave signal generator 106 and the cosine wave signal generator 112 of the frequency shift processing unit 102. As shown in FIG. 2, the modulation frequency control unit 126 includes a velocity setting unit 202 and a modulation frequency calculation unit 204.

The velocity setting unit 202 sets velocity information indicating the velocity v of the sound source that moves away. The velocity v may be designated by the operator. The velocity v may be a fixed value. The velocity v may be variable, that is, may change over time. For example, the velocity setting unit 202 holds, as the velocity information, a velocity change table that records the time change of the velocity v designated by the user, and outputs a signal indicating the velocity v to the modulation frequency calculation unit 204 in accordance with the velocity change table.

The modulation frequency calculation unit 204 calculates the modulation frequency f1 from the velocity v set by the velocity setting unit 202. For example, the modulation frequency calculation unit 204 calculates the modulation frequency f1 from the velocity v and the reference frequency fa in accordance with equation (2).

The modulation frequency calculation unit 204 outputs a signal representing the calculated modulation frequency f1 to the frequency shift processing unit 102. If the velocity v is a fixed value, the modulation frequency f1 is a fixed value, too. If the velocity v changes over time, the modulation frequency f1 changes over time, too.

Referring back to FIG. 1, the amplitude control unit 128 is connected to the output terminal 122 of the frequency shift processing unit 102. The amplitude control unit 128 controls the amplitude of the acoustic signal output from the output terminal 122. Specifically, the amplitude control unit 128 amplifies the acoustic signal output from the output terminal 122 at an amplification factor or a gain that may be designated by the operator.

The amplitude control unit 130 is connected to the output terminal 124 of the frequency shift processing unit 102. The amplitude control unit 130 controls the amplitude of the acoustic signal output from the output terminal 124. Specifically, the amplitude control unit 130 amplifies the acoustic signal output from the output terminal 124 at an amplification factor or a gain that may be designated by the operator.

The parameter setting unit 132 sets a parameter set including, as parameters, the velocity v used by the modulation frequency control unit 126, the amplification factor used by the amplitude control unit 128, and the amplification factor used by the amplitude control unit 130. The parameter set may include the reference frequency fa as a parameter. The parameters may be set based on an input from the operator.

The configuration shown in FIG. 1 is merely an example, and the acoustic signal processing apparatus 100 may have a configuration different from that shown in FIG. 1. For example, the frequency shift processing unit 102 may include a single output terminal. Specifically, the subtractor 120, the output terminal 124, and the amplitude control unit 130 may be removed from the acoustic signal processing apparatus 100. Alternatively, the adder 118, the output terminal 122, and the amplitude control unit 128 may be removed from the acoustic signal processing apparatus 100.

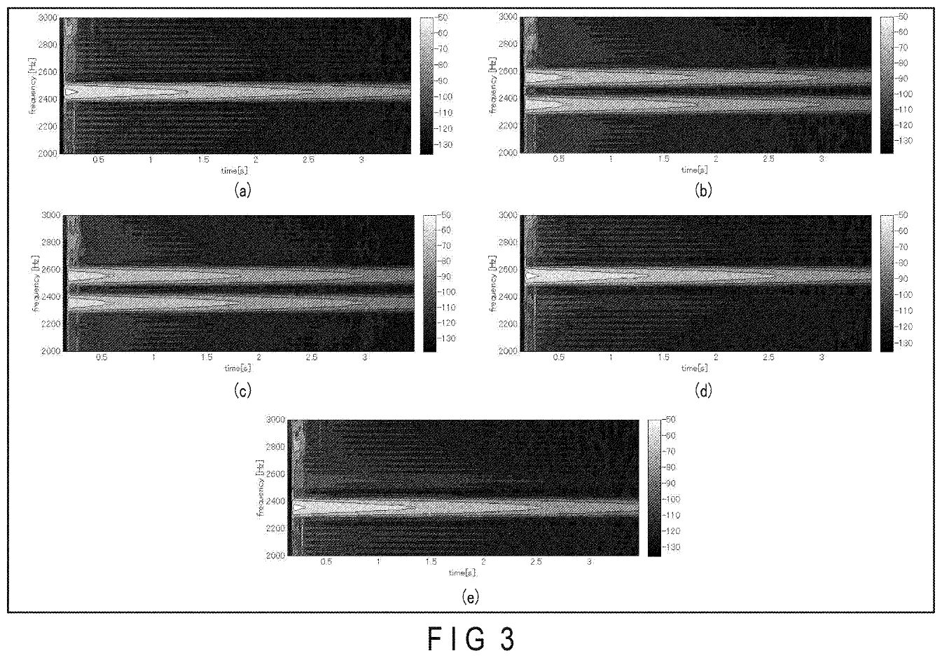

FIG. 3 schematically shows a frequency shift achieved by the frequency shift processing unit 102 shown in FIG. 1. In FIG. 3, (a) shows a sound of a bell corresponding to the acoustic signal input to the frequency shift processing unit 102, (b) shows the output signal of the multiplier 108, (c) shows the output signal of the multiplier 114, (d) shows the output signal of the adder 118, and (e) shows the output signal of the subtractor 120. In this example, the modulation frequency f1 is set to 100 Hz. The modulation frequency f1 of 100 Hz is obtained by, for example, setting the velocity v to about 38 m/s and the reference frequency fa to 1 kHz.

As shown in (d) of FIG. 3, an acoustic signal whose frequency is shifted by 100 Hz is output from the output terminal 122. Also, as shown in (e) of FIG. 3, an acoustic signal whose frequency is shifted by −100 Hz is output from the output terminal 124. As can be confirmed from FIG. 3, the frequency shift processing unit 102 can shift the frequency of the bell sound.

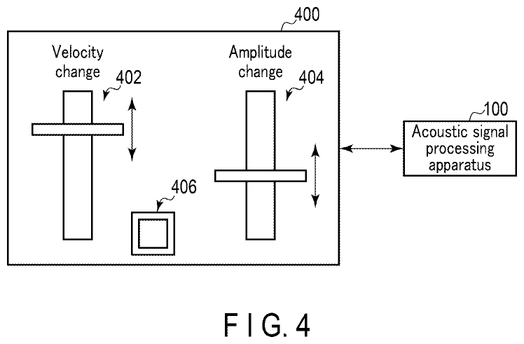

FIG. 4 schematically shows an example of the hardware configuration of a user interface 400 according to the embodiment. The user interface 400 shown in FIG. 4 is connected to the acoustic signal processing apparatus 100 and used to set the above-described parameter set.

The user interface 400 includes a slider 402 used to adjust the velocity v, a slider 404 used to adjust the amplification factor of the amplitude control unit 128, a slider (not shown) used to adjust the amplification factor of the amplitude control unit 130, and a memory button 406. If the operator presses the memory button 406, the acoustic signal processing apparatus 100 outputs, via a loudspeaker or a headphone connected to it, an acoustic signal to which an effect of this method is applied. The operator operates the sliders 402 and 404 to adjust the parameters while hearing a sound output from the loudspeaker or the headphone. The user interface 400 transmits operation signals indicating the operations of the sliders 402 and 404 to the parameter setting unit 132 of the acoustic signal processing apparatus 100. The parameter setting unit 132 sets the parameters in accordance with the operation signals received from the user interface 400. For example, the acoustic signal processing apparatus 100 generates a velocity change table in accordance with the operation signal indicating the operation of the slider 402.

Note that the user interface 400 may be implemented not by hardware but by software. Specifically, the parameter setting unit 132 may display, on a display device, a graphic user interface (GUI) corresponding to the user interface 400. In this case, the operator adjusts the parameters by operating an input device such as a mouse.

The acoustic signal processing apparatus 100 having the above-described configuration can shift the frequency of an acoustic signal. This makes it possible to easily implement sound image localization in the up-down direction. For example, an acoustic signal whose frequency is shifted is output from a headphone or one or more omnidirectional loudspeakers arranged in the horizontal direction, thereby obtaining a feeling of localization in which the sound source moves in the upward or downward direction.

A moving sound source application using the acoustic signal processing apparatus 100 shown in FIG. 1 will be described next.

Any of moving sound source applications to be described below can perform signal processing at low operation cost and can be implemented in real time by a small-scale computer or circuit.

If the sound source comes closer, the frequency becomes high. If the pitch transitions from a low tone to a high tone, the user has an illusion as if the sound source moves in the upward direction. A feeling of localization in the upward direction is created using this illusion.

If the sound source moves away, the frequency becomes low. If the pitch transitions from a high tone to a low tone, the user has an illusion as if the sound source moves in the downward direction. A feeling of localization in the downward direction is created using this illusion.

Also, if transition of the velocity of the sound source coming closer or moving away is appropriately given, it is possible to create a more realistic feeling of localization in the upward or downward direction as compared to a case where the velocity is constant.

It is also possible to impart a volume change. When presenting localization to rise in the upward direction, two cases can be assumed concerning imparting of a volume change. For example, if the sound source increases the volume along with the increase of the rotation speed, like a helicopter or a drone, the volume is increased as the sound source moves in the upward direction. Conversely, in a case of a sound source with a constant volume (bird song or the like), the volume is decreased as the sound source moves in the upward direction. This is because the longer the distance is, the smaller the volume is. That is, imparting of a volume change can be changed any way depending on the contents.

### <Moving Sound Source Application (A)>

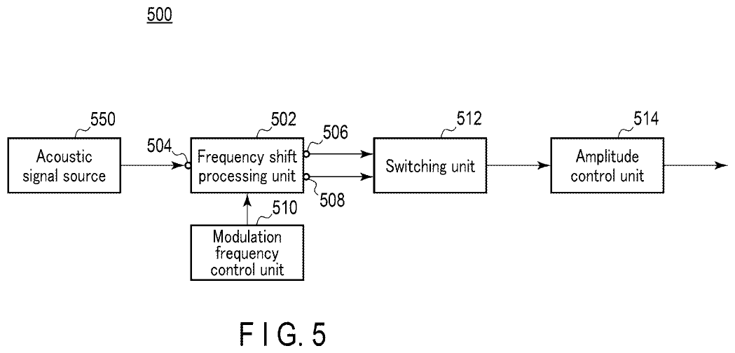

FIG. 5 schematically shows an acoustic signal processing apparatus 500 according to a moving sound source application (A). As shown in FIG. 5, the acoustic signal processing apparatus 500 includes a frequency shift processing unit 502, a modulation frequency control unit 510, a switching unit 512, and an amplitude control unit 514.

The frequency shift processing unit 502 has the same configuration as the frequency shift processing unit 102 shown in FIG. 1. The frequency shift processing unit 502 includes an input terminal 504 corresponding to the input terminal 104 of the frequency shift processing unit 102, and output terminals 506 and 508 corresponding to the output terminals 122 and 124 of the frequency shift processing unit 102. The modulation frequency control unit 510 has the same configuration as the modulation frequency control unit 126 shown in FIG. 2. The frequency shift processing unit 502 performs SSB modulation on an acoustic signal in accordance with the modulation frequency f1 controlled by the modulation frequency control unit 510.

An acoustic signal source 550 that supplies an acoustic signal is connected to the input terminal 504 of the frequency shift processing unit 502. The output terminals 506 and 508 of the frequency shift processing unit 502 are connected to the amplitude control unit 514 via the switching unit 512.

The switching unit 512 switches which one of the output terminals 506 and 508 the amplitude control unit 514 is to be connected. The amplitude control unit 514 controls the amplitude of the acoustic signal output from the switching unit 512. For example, the amplitude control unit 514 amplifies the acoustic signal output from the switching unit 512 at an amplification factor designated by the operator.

For example, the acoustic signal source 550 supplies an acoustic signal obtained by recording an ambulance siren. The switching unit 512 switches the connection destination of the amplitude control unit 514 from the output terminal 506 to the output terminal 508, and in synchronism with the switching, the amplitude control unit 514 increases the amplitude of the acoustic signal output from the switching unit 512 near the switching timing. This can make the user have an illusion as if an ambulance comes close, passes before his/her eyes, and moves away.

In this way, the acoustic signal processing apparatus 500 can simulate a moving sound source such as an ambulance.

Note that if the modulation frequency f1 is variable, the switching unit 512 may be removed from the acoustic signal processing apparatus 500. If the acoustic signal processing apparatus 500 does not include the switching unit 512, one of the output terminals 506 and 508 of the frequency shift processing unit 502 is connected to the amplitude control unit 514. For example, if the velocity v is set such that the modulation frequency f1 changes from A to −A or from −A to A, the same processing as described above can be performed.

### <Moving Sound Source Application (B)>

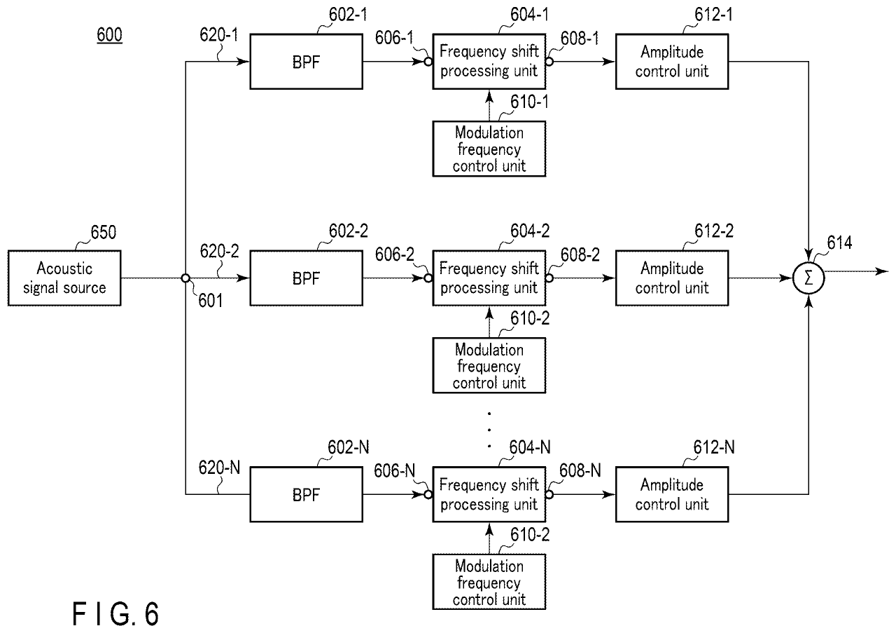

FIG. 6 schematically shows an acoustic signal processing apparatus 600 according to a moving sound source application (B). As shown in FIG. 6, the acoustic signal processing apparatus 600 includes a splitter 601, N bandpass filters 602-1 to 602-N, N frequency shift processing units 604-1 to 604-N, N modulation frequency control units 610-1 to 610-N, N amplitude control units 612-1 to 612-N, and an adder 614, where N is an integer of 2 or more.

An acoustic signal source 650 that supplies an acoustic signal is connected to the acoustic signal processing apparatus 600. In the acoustic signal processing apparatus 600, the splitter 601 branches the acoustic signal from the acoustic signal source 650 to N paths 620-1 to 620-N.

In a path 620-i, a bandpass filter 602-i, a frequency shift processing unit 604-i, and an amplitude control unit 612-i are provided. Here, i is an arbitrary integer (1≤i≤N). The bandpass filters 602-1 to 602-N provided in the paths 620-1 to 620-N, respectively, have different passbands. The passband of the bandpass filter 602-i may partially overlap the passband of the bandpass filter 602-(i+1). The center frequency of the bandpass filter 602-i is defined as fa(i), and fa(1)<fa(2)< . . . <fa(N) is set. As the bandpass filters 602-1 to 602-N, for example, 1/1 octave band filters or ⅓ octave band filters may be used. If 1/1 octave band filters are used, fa(i)/fa(i−1)=2 holds.

Each of the frequency shift processing units 604-1 to 604-N has the same configuration as the frequency shift processing unit 102 shown in FIG. 1. The frequency shift processing unit 604-i includes an input terminal 606-i corresponding to the input terminal 104 of the frequency shift processing unit 102, and an output terminal 608-i corresponding to one of the output terminals 122 and 124 of the frequency shift processing unit 102. The input terminal 606-i is connected to the bandpass filter 602-i, and the output terminal 608-i is connected to the amplitude control unit 612-i.

Each of the modulation frequency control units 610-1 to 610-N has the same configuration as the modulation frequency control unit 126 shown in FIG. 2. The center frequency fa(i) of the bandpass filter 602-i is used as the reference frequency of the path 620-i. The modulation frequency control unit 610-i calculates a modulation frequency f(i) from the velocity v and the reference frequency fa(i) in accordance with

$$f ( i ) = - \frac{v}{c + v} f a ( i ) \qquad ( i )$$

The frequency shift processing unit 604-i performs SSB modulation on the acoustic signal in accordance with the modulation frequency f(i) decided by the modulation frequency control unit 610-i.

The amplitude control unit 612-i controls the amplitude of the acoustic signal whose frequency is shifted and which is output from the frequency shift processing unit 604-i. For example, the amplitude control unit 612-i amplifies the acoustic signal output from the frequency shift processing unit 604-i at an amplification factor designated by the user. Different amplification factors may be set for the amplitude control units 612-1 to 612-N. For example, if the acoustic signal that passes through the path 620-i is unnecessary, the amplification factor of the amplitude control unit 612-i may be set to zero.

The paths 620-1 to 620-N are coupled by the adder 614. The adder 614 adds the acoustic signals output from the amplitude control units 612-1 to 612-N and outputs a thus obtained acoustic signal.

The acoustic signal processing apparatus 600 having the above-described configuration separates an acoustic signal into acoustic signals of different frequency bands, applies, for each frequency band, a frequency shift according to the frequency band to the acoustic signal of the frequency band, and adds the acoustic signals to which the frequency shifts are applied. The splitter 601 and the bandpass filters 602-1 to 602-N described above function as a separation unit that separates an input acoustic signal into acoustic signals of different frequency bands.

In the Doppler shift, a frequency change is proportional to a frequency. On the other hand, in SSB modulation, all frequencies are uniformly shifted. Since the moving sound source application (B) performs SSB modulation on each frequency band, the frequency change by the Doppler shift can be reproduced.

An example of the moving sound source application (B) will be described.

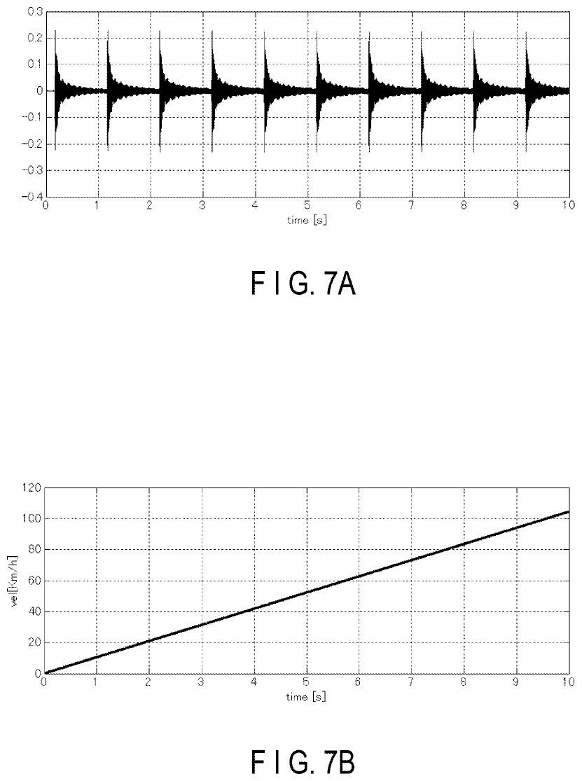

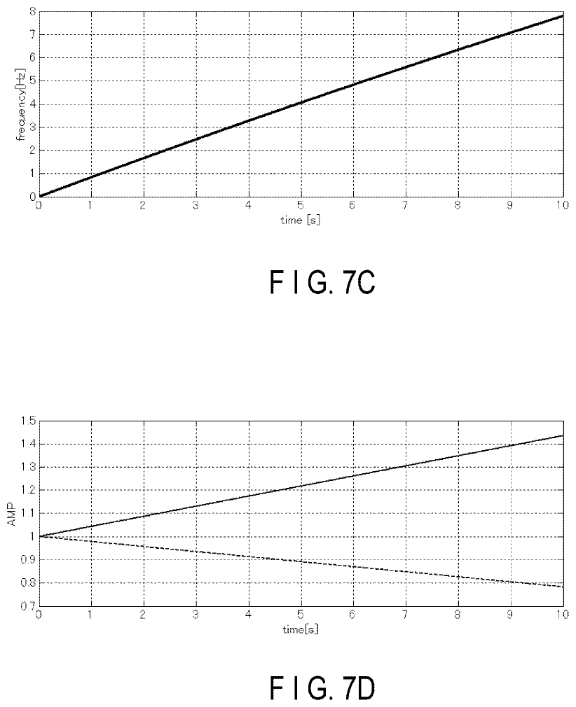

In the example, a bell sound shown in FIG. 7A is used as an acoustic signal, and a velocity change table that increases the velocity v along with the elapse of time, which is shown in FIG. 7B, is used. As the bandpass filters 602-1 to 602-N, 21 ⅓ octave band filters are used. Center frequencies fa(1) to fa(21) of the bandpass filters 602-1 to 602-21 are fa(1)=100 Hz, fa(2)=125 Hz, fa(3)=160 Hz, fa(4)=200 Hz, fa(5)=250 Hz, fa(6)=315 Hz, fa(7)=400 Hz, fa(8)=500 Hz, fa(9)=630 Hz, fa(10)=800 Hz, fa(11)=1,000 Hz, fa(12)=1,250 Hz, fa(13)=1,600 Hz, fa(14)=2,000 Hz, fa(15)=2,500 Hz, fa(16)=3,100 Hz, fa(17)=4,000 Hz, fa(18)=5,000 Hz, fa(19)=6,300 Hz, fa(20)=8,000 Hz, and fa(21)=10,000 Hz. Like the modulation frequency f(1) shown in FIG. 7C, the modulation frequencies f(1) to f(21) become high along with the elapse of time. If the output terminal 608-i of the frequency shift processing unit 604-i is a positive-side output terminal, the amplification factor is increased along with the elapse of time, as indicated by a solid line in FIG. 7D. If the output terminal 608-i of the frequency shift processing unit 604-i is a negative-side output terminal, the amplification factor is decreased along with the elapse of time, as indicated by a broken line in FIG. 7D.

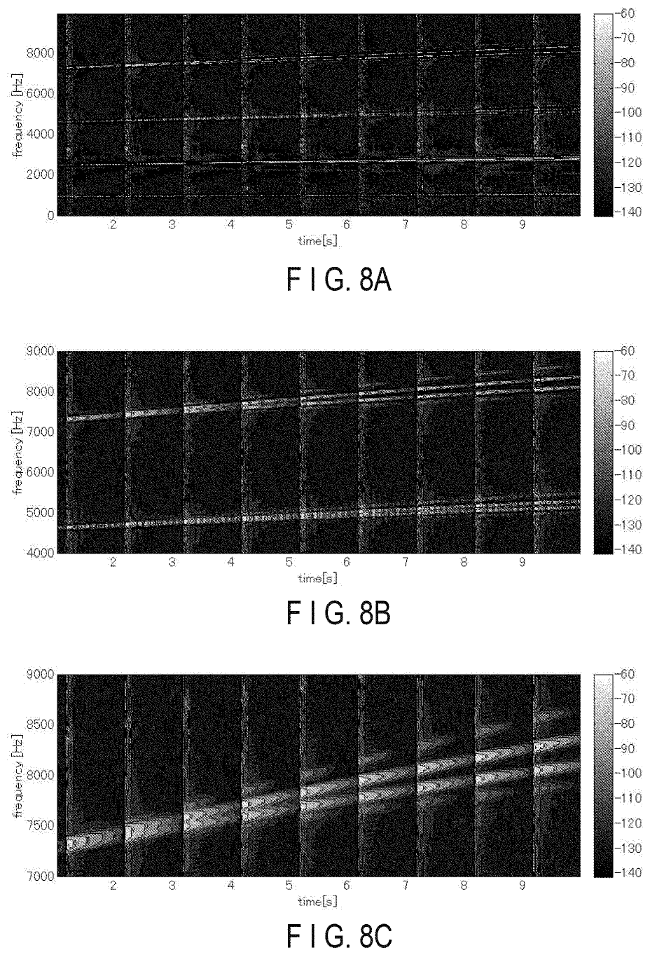

FIG. 8A shows an acoustic signal output from the acoustic signal processing apparatus 600 in a case where the positive-side output terminal of the frequency shift processing unit 604-i is used as the output terminal 608-1. FIG. 8B shows a part of the graph shown in FIG. 8A in an enlarged state, and FIG. 8C shows a part of the graph shown in FIG. 8B in an enlarged state.

As shown in FIGS. 8A, 8B, and 8C, the frequency of the bell sound rises along with the elapse of time. If the acoustic signal shown in FIG. 8A is output from a loudspeaker, it can be heard as if the bell moves upward.

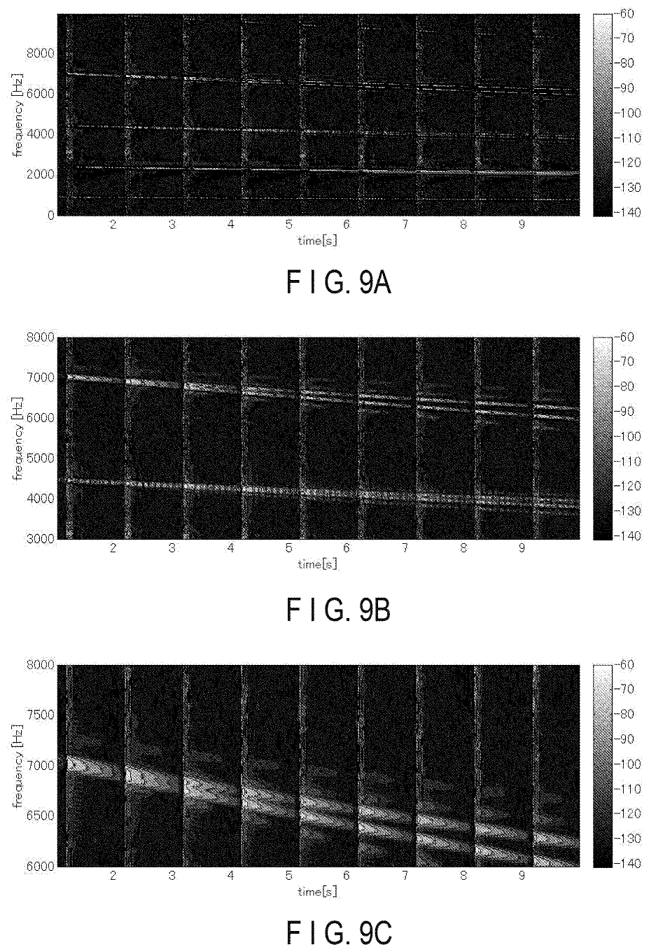

FIG. 9A shows an acoustic signal output from the acoustic signal processing apparatus 600 in a case where the negative-side output terminal of the frequency shift processing unit 604-i is used as the output terminal 608-i. FIG. 9B shows a part of the graph shown in FIG. 9A in an enlarged state, and FIG. 9C shows a part of the graph shown in FIG. 9B in an enlarged state.

As shown in FIGS. 9A, 9B, and 9C, the frequency of the bell sound lowers along with the elapse of time. If the acoustic signal shown in FIG. 9A is output from a loudspeaker, it can be heard as if the bell moves downward.

The bell sound shown in FIG. 7A includes a sound of about 7,000 Hz. The frequency of 7,000 Hz is located at the intermediate point between 6,300 Hz and 8,000 Hz, and passes through an octave band filter whose center frequency is 6, 300 Hz and an octave band filter whose center frequency is 8,000 Hz. For this reason, SSB modulation is performed on the sound of 7,000 Hz in two paths. As a result, as shown in FIGS. 8B, 8C, 9B, and 9C, the sound of 7,000 Hz is separated into two sounds and is heard like beats. The acoustic signal processing apparatus 600 according to the moving sound source application (B) is preferably used within such a velocity range that the separation is not cared. In this example, the allowable range is up to about 10 sec.

### <Moving Sound Source Application (C)>

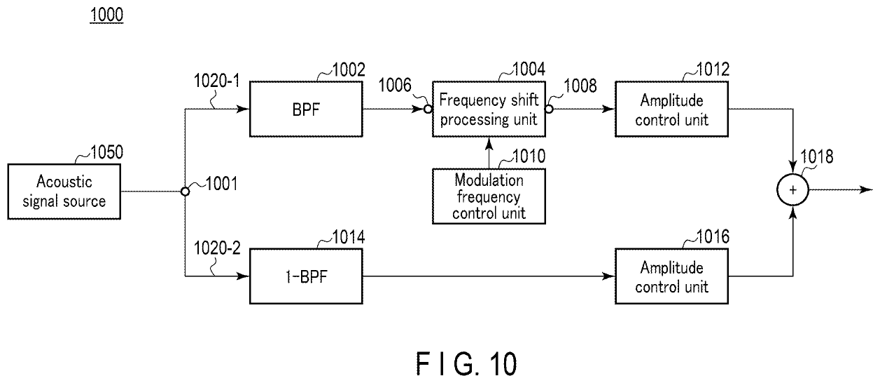

FIG. 10 schematically shows an acoustic signal processing apparatus 1000 according to a moving sound source application (C). As shown in FIG. 10, the acoustic signal processing apparatus 1000 includes a splitter 1001, a bandpass filter 1002, a frequency shift processing unit 1004, a modulation frequency control unit 1010, an amplitude control unit 1012, a band-stop filter 1014, an amplitude control unit 1016, and an adder 1018.

An acoustic signal source 1050 that supplies an acoustic signal is connected to the acoustic signal processing apparatus 1000. In the moving sound source application (C), an acoustic signal having a broad frequency band, like white noise, is handled. The splitter 1001 branches the acoustic signal from the acoustic signal source 1050 into two paths 1020-1 and 1020-2. In the path 1020-1, the bandpass filter 1002, the frequency shift processing unit 1004, and the amplitude control unit 1012 are provided. In the path 1020-2, the band-stop filter 1014 and the amplitude control unit 1016 are provided.

The bandpass filter 1002 filters the acoustic signal propagating through the path 1020-1. Specifically, the bandpass filter 1002 passes frequencies within a predetermined passage range corresponding to its passband and attenuates frequencies outside the predetermined passage range.

The frequency shift processing unit 1004 has the same configuration as the frequency shift processing unit 102 shown in FIG. 1. The frequency shift processing unit 1004 includes an input terminal 1006 corresponding to the input terminal 104 of the frequency shift processing unit 102, and an output terminal 1008 corresponding to one of the output terminals 122 and 124 of the frequency shift processing unit 102. The input terminal 1006 is connected to the bandpass filter 1002, and the output terminal 1008 is connected to the amplitude control unit 1012.

The modulation frequency control unit 1010 has the same configuration as the modulation frequency control unit 126 shown in FIG. 2. The modulation frequency control unit 1010 calculates the modulation frequency f1 from the reference frequency fa and the velocity v in accordance with, for example, equation (2), and outputs a signal representing the modulation frequency f1 to the frequency shift processing unit 1004. Here, the center frequency of the bandpass filter 1002 is used as the reference frequency fa. The frequency shift processing unit 1004 performs SSB modulation on the acoustic signal that has passed through the bandpass filter 1002 in accordance with the modulation frequency f1 decided by the modulation frequency control unit 1010.

The amplitude control unit 1012 controls the amplitude of the acoustic signal whose frequency is shifted and which is output from the frequency shift processing unit 1004. For example, the amplitude control unit 1012 amplifies the acoustic signal output from the frequency shift processing unit 1004 at an amplification factor designated by the operator. Typically, the amplitude control unit 1012 increases the amplitude of the acoustic signal output from the frequency shift processing unit 1004.

The band-stop filter 1014 filters the acoustic signal propagating through the path 1020-2. The band-stop filter 1014 performs an operation inverse to the bandpass filter 1002. Specifically, the band-stop filter 1014 attenuates frequencies within the predetermined passage range and passes frequencies outside the predetermined passage range. For example, if the passband of the bandpass filter 1002 is 100 Hz to 500 Hz, the band-stop filter 1014 attenuates frequencies within the range of 100 Hz to 500 Hz, and passes frequencies outside that range. The amplitude control unit 1016 controls the amplitude of the acoustic signal that has passed through the band-stop filter 1014. For example, the amplitude control unit 1016 amplifies the acoustic signal that has passed through the band-stop filter 1014 at an amplification factor designated by the operator. Typically, the amplitude control unit 1016 decreases the amplitude of the acoustic signal that has passed through the band-stop filter 1014. For example, if the acoustic signal that propagates through the path 1020-2 is unnecessary, the amplification factor of the amplitude control unit 1016 may be set to zero.

The paths 1020-1 and 1020-2 are coupled by the adder 1018. The adder 1018 adds the acoustic signal output from the amplitude control unit 1012 and the acoustic signal output from the amplitude control unit 1016 and outputs a thus obtained acoustic signal.

Note that the band-stop filter 1014, the amplitude control unit 1016, and the adder 1018 may be removed from the acoustic signal processing apparatus 1000.

The acoustic signal processing apparatus 1000 having the above-described configuration performs SSB modulation for a predetermined frequency band but does not perform SSB modulation for the remaining frequency bands. That is, the frequency band to perform SSB modulation is limited. Hence, frequency separation at a band boundary described concerning the moving sound source application (B) does not occur. As a result, an acoustic signal having a broad frequency band, like white noise, can be handled.

An example of the moving sound source application (C) will be described.

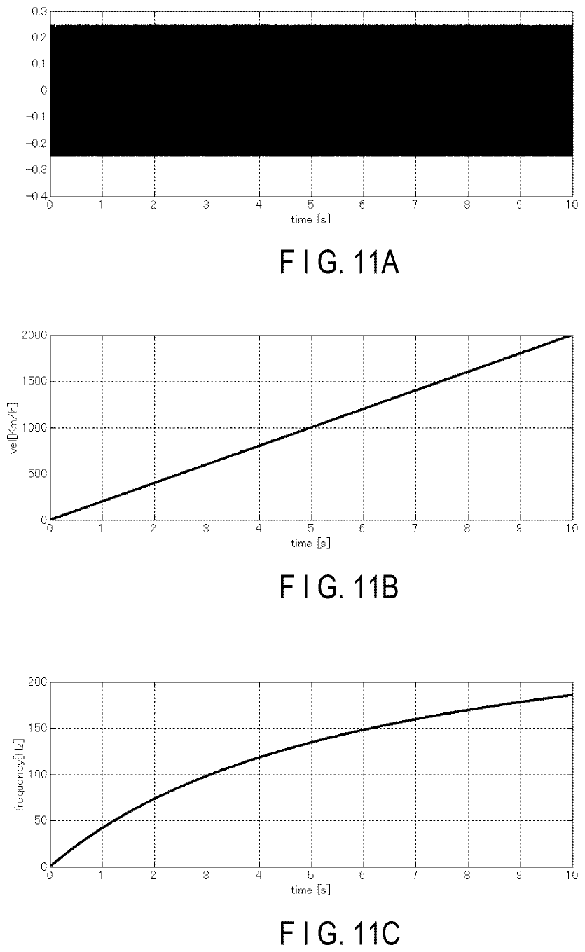

In the example, a random sound shown in FIG. 11A is used as an acoustic signal, and a velocity change table that increases the velocity v along with the elapse of time, which is shown in FIG. 11B, is used. The bandpass filter 1002 has a passband of 100 Hz to 500 Hz, and the reference frequency fa is 300 Hz. In this case, the modulation frequency f1 rises along with the elapse of time, as shown in FIG. 11C. The gain of the amplitude control unit 1012 is 12 dB, and the gain of the amplitude control unit 1016 is −36 dB.

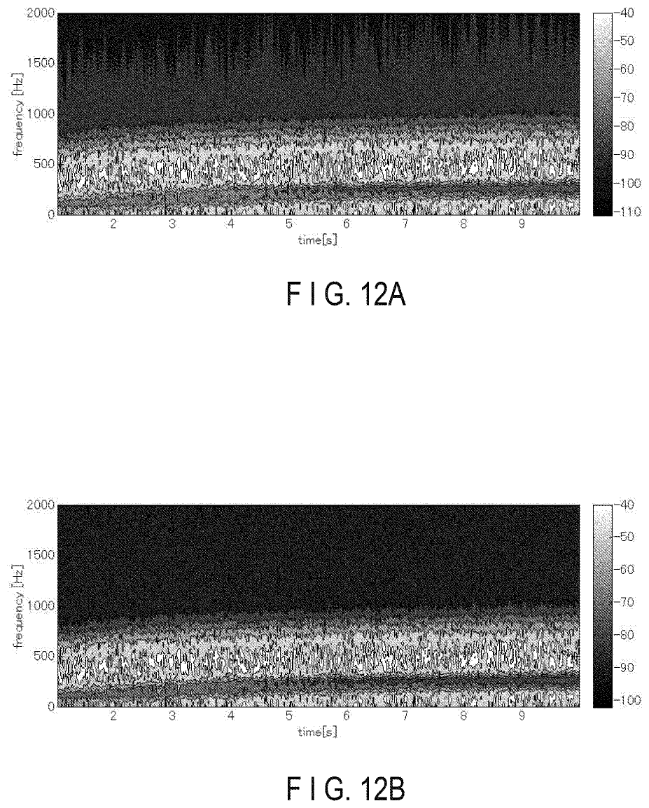

FIG. 12A shows the output signal of the amplitude control unit 1012 in a case where the positive-side output terminal of the frequency shift processing unit 1004 is used, and FIG. 12B shows the acoustic signal output from the acoustic signal processing apparatus 1000 in a case where the positive-side output terminal of the frequency shift processing unit 1004 is used. As shown in FIGS. 12A and 12B, the frequency rises along with the elapse of time. The background random sound that is the output signal of the amplitude control unit 1016 has a position anchor function, like a sound of rain. If the acoustic signal shown in FIG. 12A or 12B is output from a loudspeaker, it can be heard as if the sound source moves upward, like a sound in launch of a rocket.

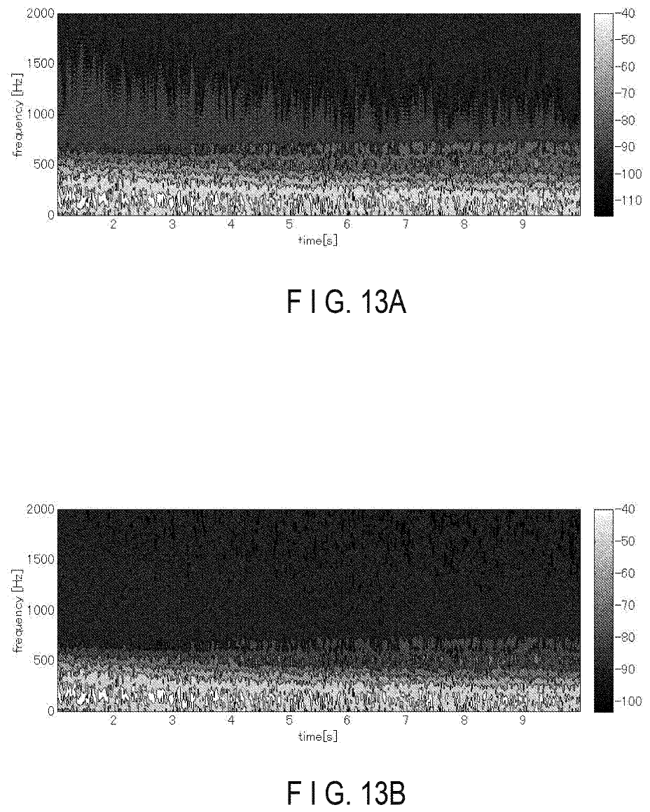

FIG. 13A shows the output signal of the amplitude control unit 1012 in a case where the negative-side output terminal of the frequency shift processing unit 1004 is used, and FIG. 13B shows the acoustic signal output from the acoustic signal processing apparatus 1000 in a case where the negative-side output terminal of the frequency shift processing unit 1004 is used. As shown in FIGS. 13A and 13B, the frequency lowers along with the elapse of time. The background random sound that is the output signal of the amplitude control unit 1016 has a position anchor function, like a sound of rain. If the acoustic signal shown in FIG. 13A or 13B is output from a loudspeaker, it can be heard as if the sound source moves downward.

A series of processes in each of the above-described acoustic signal processing apparatuses may be implemented by, for example, processing circuitry including one or more processors. The series of processes may be implemented by causing a general-purpose processor such as a central processing unit (CPU) to execute a program, that is, by software. The series of processes may be implemented by a dedicated processor such as a field programmable gate array (FPGA) or an Application Specific Integrated Circuit (ASIC), that is, by hardware. The series of processes may be implemented using both software and hardware.

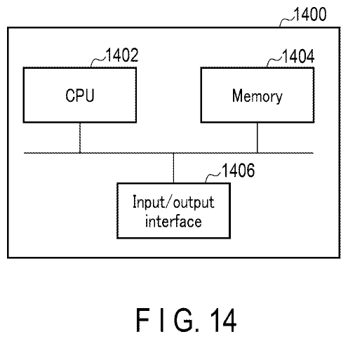

FIG. 14 schematically shows an example of the hardware configuration of a computer 1400 that can implement the acoustic signal processing apparatus according to the embodiment. As shown in FIG. 14, the computer 1400 includes a CPU 1402, a memory 1404, and an input/output interface 1406.

The memory 1404 includes a volatile memory such as a random access memory (RAM) and a nonvolatile memory such as a hard disk drive. The memory 1404 stores various kinds of programs including an acoustic signal processing program and various kinds of data including velocity information.

The CPU 1402 operates in accordance with a program stored in the memory 1404. When executed by the CPU 1402, the acoustic signal processing program causes the CPU 1402 to perform processing described concerning the acoustic signal processing apparatus 100 shown in FIG. 1, the acoustic signal processing apparatus 500 shown in FIG. 5, the acoustic signal processing apparatus 600 shown in FIG. 6, or the acoustic signal processing apparatus 1000 shown in FIG. 10. For example, in accordance with the acoustic signal processing program, the CPU 1402 functions as the frequency shift processing unit 102, the modulation frequency control unit 126, the amplitude control units 128 and 130, and the parameter setting unit 132 included in the acoustic signal processing apparatus 100. Specifically, the CPU 1402 operates as the frequency shift processing unit 102, the modulation frequency control unit 126, the amplitude control units 128 and 130, and the parameter setting unit 132.

The input/output interface 1406 includes an interface configured to connect an input device and an output device. The input device is a device that allows the operator to input information. Examples of the input device include the user interface 400 shown in FIG. 4, a keyboard, and a mouse. The output device is a device that outputs information. Examples of the output device include a display device, a loudspeaker, and a headphone.

A program such as an acoustic signal processing program may be stored in a computer-readable recording medium and provided to the computer 1400. In this case, the computer 1400 includes a drive configured to read out data from the recording medium and acquires a program from the recording medium. Examples of the recording medium include a magnetic disk, an optical disk (a CD-ROM, a CD-R, a DVD-ROM, a DVD-R, or the like), a magnetooptical disk (an MO or the like), and a semiconductor memory. The program may be distributed via a communication network. Specifically, the program may be stored in a server on the communication network, and the computer 1400 may download the program from the server.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An acoustic signal processing apparatus comprising processing circuitry, the processing circuitry comprising:
a first modulation frequency control unit configured to control a first modulation frequency based on velocity information indicating a velocity of a sound source;
a first frequency shift processing unit configured to perform single-sideband (SSB) modulation on a first acoustic signal in accordance with the first modulation frequency to generate a first modulated acoustic signal; and
a first amplitude control unit configured to control an amplitude of the first modulated acoustic signal.

2. The apparatus according to claim 1, wherein the first modulated acoustic signal is a first acoustic signal whose frequency is shifted by the first modulation frequency.

3. The apparatus according to claim 1, wherein
the velocity information indicates a time change of the velocity, and
the first modulation frequency control unit controls the first modulation frequency by converting the velocity of the sound source into a Doppler shift amount.

4. The apparatus according to claim 1, wherein the processing circuitry further comprises:
a splitter configured to branch an input acoustic signal to generate acoustic signals, the acoustic signals including the first acoustic signal and a second acoustic signal;
bandpass filters having different passbands and configured to filter the acoustic signals;
frequency shift processing units configured to perform the SSB modulation on the acoustic signals that have passed through the bandpass filters to generate modulated acoustic signals;
amplitude control units configured to control amplitudes of the modulated acoustic signals; and
an adder configured to add the modulated acoustic signals that have undergone amplitude control, and
wherein the bandpass filters include a first bandpass filter configured to filter the first acoustic signal, and a second bandpass filter configured to filter the second acoustic signal, and
the frequency shift processing units include the first frequency shift processing unit configured to perform the SSB modulation on the first acoustic signal that has passed through the first bandpass filter in accordance with the first modulation frequency to generate the first modulated acoustic signal, and a second frequency shift processing unit configured to perform the SSB modulation on the second acoustic signal that has passed through the second bandpass filter in accordance with a second modulation frequency different from the first modulation frequency to generate a second modulated acoustic signal.

5. The apparatus according to claim 1, wherein the processing circuitry further comprises:
a splitter configured to branch an input acoustic signal to generate the first acoustic signal and a second acoustic signal;
a bandpass filter having a predetermined passband and configured to filter the first acoustic signal;
a band-stop filter configured to perform an operation inverse to the bandpass filter and filter the second acoustic signal;
a second amplitude control unit configured to control an amplitude of the second acoustic signal that has passed through the band-stop filter; and
an adder configured to add the first modulated acoustic signal that has undergone amplitude control and the second acoustic signal that has undergone amplitude control, and
wherein the first frequency shift processing unit performs the SSB modulation on the first acoustic signal that has passed through the bandpass filter in accordance with the first modulation frequency to generate the first modulated acoustic signal.

6. The apparatus according to claim 1, wherein the processing circuitry further comprises a parameter setting unit configured to provide a graphical user interface (GUI) used to input the velocity information and amplitude information used for control of the amplitude.

7. The apparatus according to claim 1, wherein the processing circuitry further comprises a parameter setting unit configured to acquire, from an external apparatus, setting information including the velocity information and amplitude information used for control of the amplitude, which are input to the external apparatus.

8. An acoustic signal processing method comprising:
controlling a first modulation frequency based on velocity information indicating a velocity of a sound source;
performing single-sideband (SSB) modulation on a first acoustic signal in accordance with the first modulation frequency to generate a first modulated acoustic signal; and
controlling an amplitude of the first modulated acoustic signal.

9. A non-transitory computer readable medium including computer executable instructions, wherein the instructions, when executed by a processor, cause the processor to perform a method comprising:
controlling a first modulation frequency based on velocity information indicating a velocity of a sound source;
performing single-sideband (SSB) modulation on a first acoustic signal in accordance with the first modulation frequency to generate a first modulated acoustic signal; and
controlling an amplitude of the first modulated acoustic signal.
